(19) United States
(12) Patent Application Publication
(10) Pub. No.: US 2013/0033133 A1
(43) Pub. Date: Feb. 7, 2013

(54) STEPPING MOTOR

(71) Applicants: Jae-Young SUNG, Incheon (KR); Seul-Ki YEOM, Seoul (KR)

(72) Inventors: Jae-Young SUNG, Incheon (KR); Seul-Ki YEOM, Seoul (KR)

(73) Assignee: MOATECH CO., LTD., Incheon (KR)

(21) Appl. No.: 13/566,133

(22) Filed: Aug. 3, 2012

(30) Foreign Application Priority Data
Aug. 5, 2011 (KR) 10-2011-0078097

(51) Int. Cl. H02K 37/00

(52) U.S. Cl. 310/49.01

(57) ABSTRACT

Disclosed herein is a stepping motor. The stepping motor include a bracket including a fixing hole; a shaft supporter rotatably supporting one end of a shaft and fitted into the fixing hole; and a pressure supporter pressing and supporting the fixing hole and the shaft supporter while forming a plurality of pressure support points between the fixing hole and the shaft supporter. As such, the plurality of pressure support points is formed between the shaft supporter and the fixing hole, thereby enabling the shaft supporter to be stably press-fitted into and fixed to the fixing hole of the bracket.

### CROSS-REFERENCE TO RELATED APPLICATION

This application claims the benefit under 35 U.S.C. §119 of Korean Patent Application No. 10-2011-0078097 filed on Aug. 5, 2011 in the Korean Intellectual Property Office, the entirety of which disclosure is incorporated herein by reference.

### BACKGROUND

1. Technical Field

The present invention relates to a stepping motor, and more particularly, to a stepping motor, which includes a shaft supporter stably press-fitted into and fixed to a bracket to rotatably support one end of a shaft.

2. Description of the Related Art

Generally, a stepping motor includes a lead screw formed at one end of a shaft to engage with a pickup head and is driven to move the pickup head in an axial direction.

The background of the present invention is disclosed in Korean Patent No. 10-0547702. This background discloses a stepping motor that includes a shaft supporter, a second holder, and a shaft through-hole.

A second shaft supporter disclosed in the background includes a pivot bearing and a ball bearing.

The shaft supporter is fitted into the shaft through-hole of the second holder of a bracket in order to maintain a rotor in a coaxial state.

As in the background, when the shaft supporter is fitted into the shaft through-hole, a contact area between the shaft supporter and the shaft through-hole increases, and the outer circumference of the shaft supporter tends to contract.

Conventionally, there is a problem that a process tolerance between the shaft supporter and the shaft through-hole lowers engagement precision.

Moreover, engagement between the shaft supporter and the shaft through-hole can be deformed when external impact is applied to the shaft supporter and the shaft through-hole.

In this case, an axis of the shaft is deviated from a desired place, thereby making it difficult to obtain stable rotation of the shaft.

### BRIEF SUMMARY

An aspect of the present invention is to provide a stepping motor, in which a shaft supporter for rotatably supporting one end of a shaft is press-fitted into a fixing hole formed in a bracket, such that a plurality of pressure support points can be formed between the shaft supporter and the fixing hole.

In accordance with an aspect of the present invention, a stepping motor is provided.

The stepping motor may include a bracket including a fixing hole; a shaft supporter rotatably supporting one end of a shaft and fitted into the fixing hole; and a pressure supporter pressing and supporting the fixing hole and the shaft supporter while forming a plurality of pressure support points between the fixing hole and the shaft supporter.

The shaft supporter may include a support member having an outer diameter larger than an inner diameter of the fixing hole and rotatably supporting the one end of the shaft, and a fitting member protruding from one side of the support member and fitted into the fixing hole.

The pressure supporter may include a plurality of support projections arranged at constant intervals along an outer circumference of the fitting member to be pressed and supported by an inner circumference of the fixing hole.

The pressure supporter may include a plurality of support projections arranged at constant intervals along an inner circumference of the fixing hole to be pressed and supported by an inner circumference of the fitting member.

The stepping motor may further include a foreign matter accommodating groove formed on a connecting region between the support member and the fitting member, and having a predetermined depth inside the support member.

As such, according to the present invention, a plurality of pressure support points is formed between the shaft supporter and the fixing, thereby enabling the shaft supporter to be stably press-fitted into and fixed to a fixing hole of a bracket.

Further, the plurality of pressure support points is formed between the shaft supporter and the fixing hole such that the shaft supporter can be press-fitted into the fixing hole, whereby the shaft supporter is prevented from separating from the fixing hole due to external impact during engagement between the shaft supporter and the fixing hole.

Further, the shaft supporter prevents axis deviation of the shaft, thereby ensuring stable rotation of the shaft while preventing operating failure of the stepping motor.

Furthermore, the shaft supporter is configured to accommodate a predetermined amount of foreign matter generated upon fitting the shaft supporter into the fixing hole, thereby preventing the foreign matter from flowing into the motor.

Furthermore, the shaft supporter may extend the lifespan of the stepping motor.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a perspective view of a stepping motor according to the present invention;

FIG. 2 is a perspective view of a shaft supporter according to the present invention;

FIG. 3 is an exploded perspective view of the shaft supporter before being assembled to a bracket, according to the present invention;

FIG. 4 is a perspective view of the shaft supporter after being assembled to the bracket, according to the present invention;

FIG. 5 is a plan view of a shaft supporter according to one exemplary embodiment of the present invention;

FIG. 6 is a plan view of a fixing hole formed in a bracket according to one exemplary embodiment of the present invention;

FIG. 7 is a view of the shaft supporter press-fitted into the fixing hole, according to the exemplary embodiment of the present invention;

FIG. 8 is a plan view of a shaft supporter according to another exemplary embodiment of the present invention;

FIG. 9 is a plan view of a fixing hole formed in a bracket according to another exemplary embodiment of the present invention;

FIG. 10 illustrates a state in which the shaft supporter is press-fitted into the fixing hole according to another exemplary embodiment of the present invention; and

FIG. 11 illustrates a state in which a shaft supporter is press-fitted into a fixing hole, according to a further exemplary embodiment of the present invention.

### DETAILED DESCRIPTION

Exemplary embodiments of the present invention will now be described with reference to the accompanying drawings.

Stepping Motor Including Shaft Support

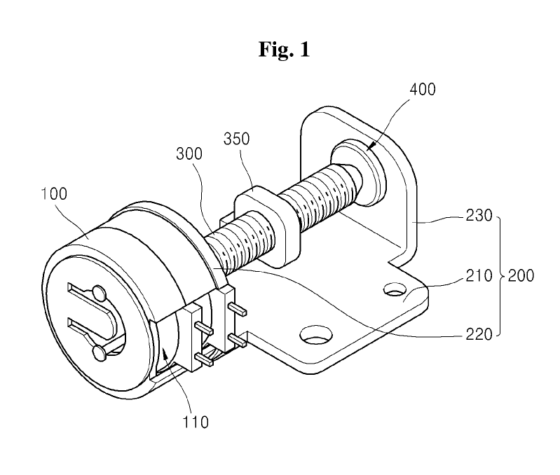

FIG. 1 shows a configuration of a stepping motor including a shaft supporter according to the present invention.

Referring to FIG. 1, the stepping motor according to the present invention includes a housing 100, a bracket 200, a shaft 300, and a shaft supporter 400.

The housing 100 receives a bobbin assembly 110 having a coil wound thereon, and a rotor assembly (not shown) disposed within the bobbin assembly 110 and including a magnet rotated by magnetic force from the bobbin assembly 110.

The bracket 200 includes a lower bracket 210 and first and second side brackets 220, 230, which are formed of one piece.

The lower bracket has a predetermined length and a predetermined width.

The first side bracket 220 is bent at one side of the lower bracket 210 to stand upright.

The second side bracket 230 is bent at one side of the lower bracket 210 to stand upright.

The first side bracket 220 is joined to one side of the housing 100 by welding or the like.

Here, each of the housing 100 and the first side bracket 220 is formed at one side thereof with a hole (not shown) through which the shaft 30 passes. Thus, one end of the shaft 300 is inserted into the magnet (not shown).

The second side bracket 230 is formed with a fixing hole 201. The fixing hole 210 has a circular shape having a predetermined inner diameter.

The shaft supporter 400 is press-fitted into and fixed in the fixing hole 201.

The shaft supporter 400 rotatably supports the other end of the shaft 300.

The rotor assembly is rotated by magnetic force generated in the bobbin assembly 110. The shaft 300 is moved in association with rotation of the rotor assembly. Here, a moving body 350 horizontally moves from side to side along a screw of the shaft 300.

Shaft Supporter

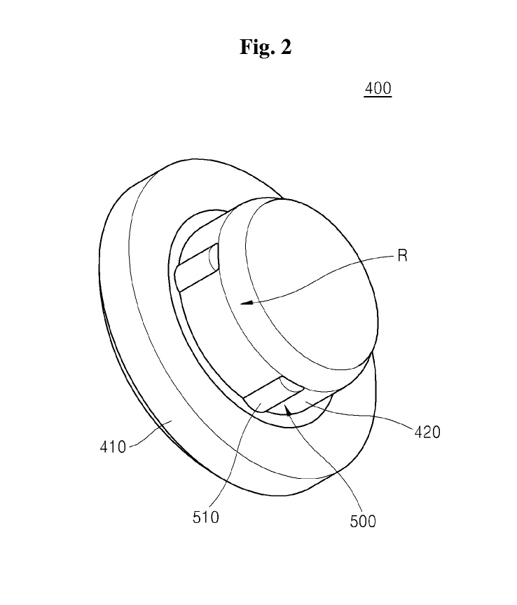

FIG. 2 shows a shaft supporter according to the present invention.

Referring to FIG. 2, the shaft supporter 400 includes a support member 410 and a fitting member 420. The support member 410 has a circular plate shape of a predetermined thickness.

The fitting member 420 protrudes from one side of the support member 410. The fitting member 420 has a cylindrical shape. The fitting member 420 is press-fitted into the fixing hole 201.

The fitting member 420 has a predetermined curvature R at one end thereof. The curvature R is a round surface for guiding the fitting member 420 to be easily fitted into the fixing hole 201.

In this invention, a pressure supporter 500 is formed on an outer circumference of the fitting member 420.

The pressure supporter 500 includes a plurality of support projections 510.

On the outer circumference of the fitting member 420, the support projections 510 are arranged at constant intervals in a circumferential direction.

Each support projection 510 has a predetermined length in a longitudinal direction of the fitting member 420. The length of each support projection 510 may be substantially the same as the length of the fitting member 420.

Each support projection 510 protrudes from the outer circumference of the fitting member 420.

Each support projection 510 may have another curvature (not shown) at one end thereof, which is joined to the curvature R of the fitting member 420.

In addition, the support member 410 is formed with a foreign matter accommodating groove 411 having a predetermined depth along a connecting portion between the support member 410 and the fitting member 420.

The foreign matter accommodating groove 411 receives foreign matter generated as the support projections 510 are pushed by the inner circumference of the fixing hole 201 when the pressure supporter 500 is fitted into the fixing hole 201.

Press-Fitting of Shaft Supporter

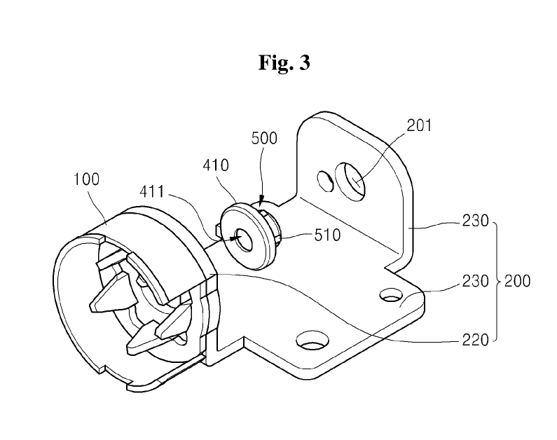

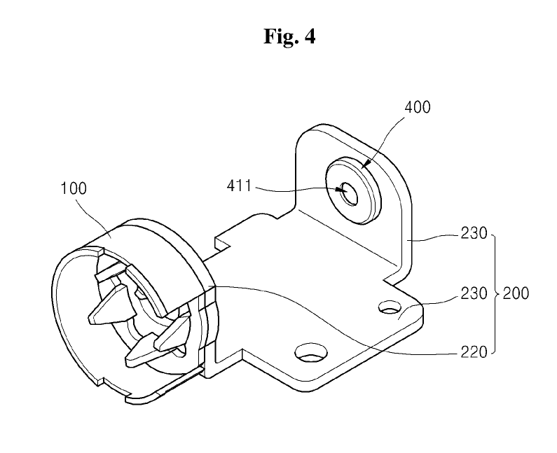

FIG. 3 is an exploded perspective view of the shaft supporter before being assembled to a bracket, according to the present invention, and FIG. 4 is a perspective view of the shaft supporter after being assembled to the bracket, according to the present invention.

Referring to FIGS. 3 and 4, the fitting member 420 of the shaft supporter 400 is press-fitted into the fixing hole 201.

At this time, the pressure supporter 500 having the plurality of support projections 510 formed along the outer circumference of the fitting member 420 is pressed and supported by the inner circumference of the fixing hole 201.

Also, one side of the support member 410 of the shaft supporter 400 is in close-contact with and supported by a side surface of the second side bracket 230.

Here, a hole 410a is formed at the center of the other side of the support member 410 to receive a ball bearing (not shown).

The ball bearing serves to rotatably support the other end of the shaft 300 shown in FIG. 1.

### Exemplary Embodiment

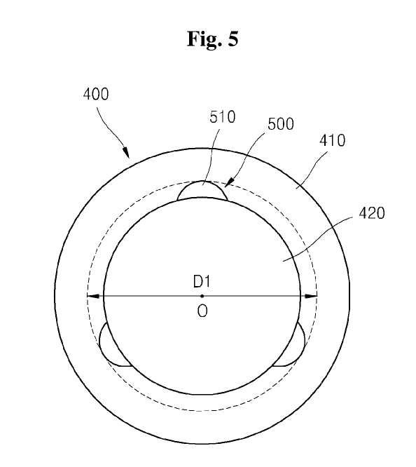

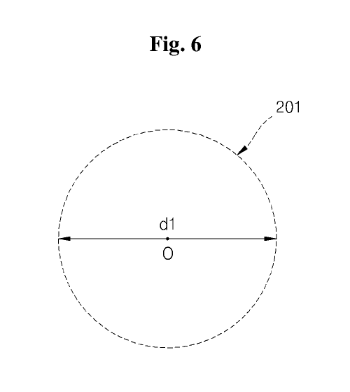

FIG. 5 is a plan view of a shaft supporter according to one exemplary embodiment of the present invention. FIG. 6 is a plan view of a fixing hole formed in a second side bracket according to the exemplary embodiment of the present invention.

Referring to FIG. 5, the shaft supporter 400 according to the exemplary embodiment is the same as described with reference to FIGS. 1 to 4.

As described above, the shaft supporter 400 includes a support member 410 and a fitting member 420. The pressure supporter 500 includes a plurality of support projections 510 formed around the outer circumference of the fitting member 420.

The outer circumference of the pressure supporter 500 has a diameter D1 in the circumferential direction of the shaft supporter 400. Here, “O” indicates the center of the shaft supporter 400.

Referring to FIG. 6, the fixing hole 201 has an inner diameter d1.

In this exemplary embodiment, the outer diameter D1 of the pressure supporter 500 may be larger than the inner diameter d1 of the fixing hole 201 within a predetermined range (D1>d1).

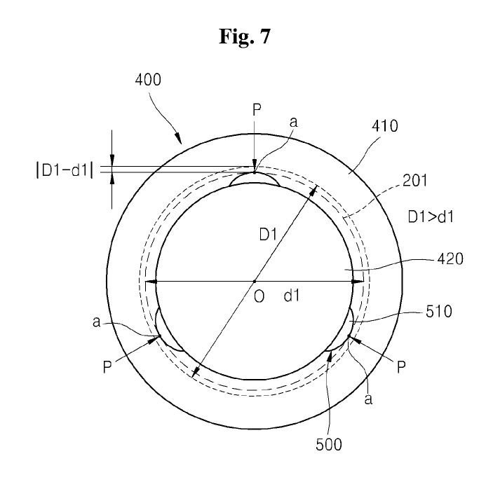

FIG. 7 is a view of the shaft supporter 400 press-fitted into the fixing hole 201, according to the exemplary embodiment of the present invention.

Referring to FIG. 7, the fitting member 420 with the pressure supporter 500 is press-fitted into the fixing hole 201.

Here, the fitting member 420 has a predetermined curvature R (see FIG. 2) at one end thereof such that the fitting member 420 can be easily fitted into the fixing hole 201.

Further, the fitting member 420 is placed inside the fixing hole 201, and the pressure supporter 500 is press-fitted inside the inner circumference of the fixing hole 201.

Here, an outer section of the pressure supporter 500 is compressed and reduced an absolute value |D1−d1| by the inner circumference of the fixing hole 201.

Further, some of the outer portion of the pressure supporter 500 is pushed in a direction opposite to the insertion direction, thereby providing foreign matter.

Here, a predetermined amount of the foreign matter is accommodated in the foreign matter accommodating groove 411 of the support member 410 shown in FIG. 2.

Therefore, the foreign matter generated due to press-fitting may not be introduced into a region where the shaft 300 is disposed. Thus, the shaft 300 can stably rotate under a condition that foreign matter is not introduced into the motor.

Also, the pressure supporter 500 having the plurality of support projections 510 forms a plurality of pressure support points (a) on the inner circumference of the fixing hole 201.

Thus, when the fitting member 420 with the pressure supporter 500 is fitted into the fixing hole 201, the pressure supporter 500 may maintain press-fitting of the fitting member 420 while forming the plurality pressure support points (a) on the inner circumference of the fixing hole 201.

At this time, each pressure support point (a) may have a pressure P formed along the center of the fixing hole 201, as shown in FIG. 7.

FIG. 7 illustrates the pressure supporter 500 including, for example, three support projections 510. Alternatively, the pressure supporter 500 may include more than three support projections 510.

Thus, the shaft supporter 400 is stably press-fitted into the fixing hole 201, and stably fixed to the second side bracket 230 via the plurality of pressure support points (a), as described above.

According to this embodiment, the shaft 300 may be stably and rotatably supported even in the event where external impact is applied to the bracket 200 or the stepping motor.

According to this embodiment, it is possible to prevent undesirable engagement between the shaft supporter 400 and the fixing hole 201 due to external impact applied thereto.

### Another Exemplary Embodiment

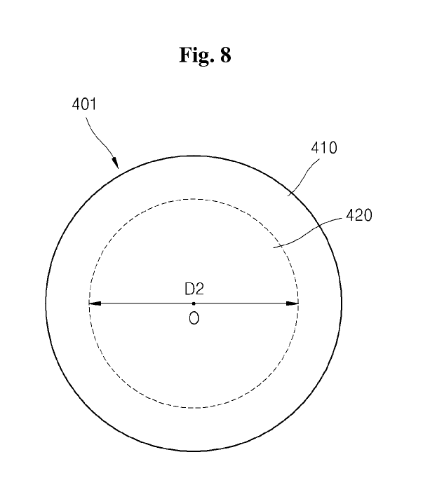

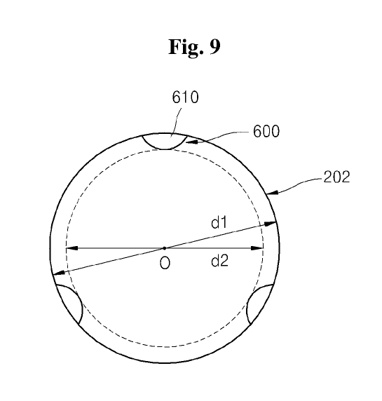

FIG. 8 is a plan view of a shaft supporter according to another exemplary embodiment of the present invention, and FIG. 9 is a plan view of a fixing hole formed in a second side bracket according to the exemplary embodiment of the present invention.

Referring to FIG. 8, a shaft supporter 401 according to this embodiment includes a support member 410 and a fitting member 420. The fitting member 420 may have a smooth outer surface.

The fitting member 420 has a diameter D2.

Referring to FIG. 9, a fixing hole 202 according to this exemplary embodiment has an inner diameter d1.

In particular, a pressure supporter 600 including a plurality of support projections 610 is formed on the inner circumference of the fixing hole 201. The plurality of support projections 610 protrudes toward the center of the fixing hole 202.

The pressure supporter 600 has a predetermined length in a longitudinal direction of the fixing hole 202.

The pressure supporter 600 may have the same shape as that of the pressure supporter 500 described above.

Here, a circumference linking outer ends of the pressure supporter 600 in the circumferential direction of the fixing hole 202 has a diameter d2.

According to this exemplary embodiment, the diameter d2 defining the outer circumference of the pressure supporter 600 is smaller than the diameter D2 of the fitting member 420 within a predetermined range (D2>d2).

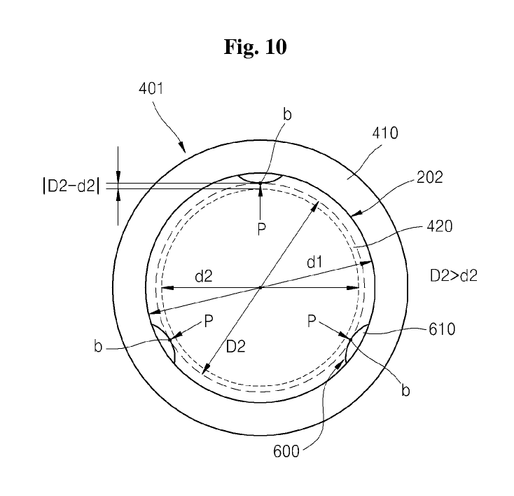

FIG. 10 illustrates a state that the shaft supporter is press-fitted into the fixing hole according to this exemplary embodiment of the present invention.

Referring to FIG. 10, the fitting member 420 is fitted into the fixing hole 202.

Here, the fitting member 420 is placed inside the fixing hole 202. The pressure supporter 600 protruding from the inner circumference of the fixing hole 202 presses the outer circumference of the fitting member 420.

Here, an outer portion of the pressure supporter 600 is compressed and reduced an absolute value |D2−d2| by the outer circumference of the fitting member 420.

Further, some of the outer portion of the pressure supporter 600 is pushed by the outer circumference of the fitting member 420, thereby providing foreign matter.

Here, a predetermined amount of the foreign matter is accommodated in the foreign matter accommodating groove 411 of the support member 410 shown in FIG. 2.

Therefore, the foreign matter generated due to press-fitting may not be introduced into a region where the shaft 300 is disposed. Thus, the shaft 300 can stably rotate under a condition that foreign matter is not introduced into the motor.

Further, in the event where foreign matter is generated outside the first side bracket 230, it is not within the region where the shaft 300 is disposed, and does not have a negative effect on rotation of the shaft 300.

Also, the pressure supporter 600 having the plurality of support projections 610 forms a plurality of pressure support points (b) on the outer circumference of the fitting member 420.

Thus, when the fitting member 420 is fitted into the fixing hole 202 with the pressure supporter 600, the pressure supporter 600 of the fixing hole 202 may maintain press-fitting of the fitting member 420 while forming the plurality pressure support points (b) on the outer circumference of the fitting member 420.

At this time, each pressure support point (b) may have a pressure P′ formed outward from the center of the fixing hole 202 as shown in FIG. 10.

FIG. 10 illustrates the pressure supporter 600 including, for example, three support projections 610. Alternatively, the pressure supporter 600 may include more than three support projections 610.

Thus, the shaft supporter 401 is stably press-fitted into the fixing hole 202, and stably fixed to the second side bracket 230 via the plurality of pressure support points (b) as described above.

According to this embodiment, the shaft 300 may be stably and rotatably supported in the event where external impact is applied to the bracket 200 or the stepping motor.

According to this embodiment, it is possible to prevent undesirable engagement between the shaft supporter 401 and the fixing hole 202 due to external impact applied thereto.

### Further Exemplary Embodiment

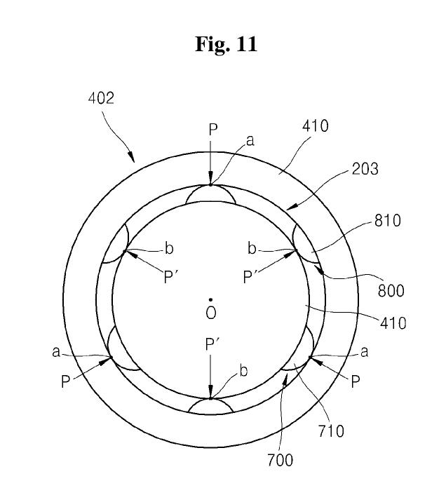

FIG. 11 illustrates a state in which a shaft supporter is press-fitted into a fixing hole, according to a further exemplary embodiment of the present invention.

Referring to FIG. 11, a shaft supporter 402 according to this exemplary embodiment includes a support member 410 and a fitting member 420.

The outer circumference of the fitting member 420 is formed with a first pressure supporter 700 having a plurality of first support projections 710.

The fixing hole 203 into which the fitting member 420 is fitted is formed with a second pressure supporter 800 having a plurality of second support projections 810.

The first pressure supporter 700 may be the same as the pressure supporter 400 shown in FIG. 7.

The second pressure supporter 800 may be the same as the pressure supporter 500 shown in FIG. 10.

The shaft supporter 402 may be fitted into and fixed in the fixing hole 203.

The first pressure supporter 700 forms a plurality of pressure support points (a) on the inner circumference of the fixing hole 203. The pressure support points (a) have a pressure P generated in a first direction.

The first pressure supporter 800 forms a plurality of pressure support points (b) on the outer circumference of the fitting member 420. The pressure support points (b) have a pressure P′ generated in a second direction.

Here, the first direction and the second direction may be opposite to each other.

Further, the first and second pressure supporters 700, 800 are alternately arranged in the fixing hole 203.

As shown in FIG. 11, when the shaft supporter 402 is press-fitted into the fixing hole 203, the shaft supporter 402 may be press-fitted into and fixed thereto while generating the pressures P, P′ in different directions within the fixing hole 203.

Therefore, the pressures P, P′ against the shaft supporter 402 may be uniformly generated within the fixing hole 203. The shaft supporter 402 is prevented from axial deviation when fitted into the fixing hole 203.

Thus, the shaft supporter 402 is stably fitted into the fixing hole 203, and stably fixed to the second side bracket 230 via the plurality of pressure support points (a) and (b) having the pressures P and P′ generated in the different directions.

According to this embodiment, the shaft 300 may be stably and rotatably supported in the event where external impact is applied to the bracket 200 or the stepping motor.

According to this embodiment, it is possible to prevent undesirable engagement between the shaft supporter 402 and the fixing hole 203 due to external impact applied thereto.

Although not shown in the drawings, each of the pressure supporters 500, 600, 700 and 800 according to the exemplary embodiments of the invention may have scratches on an outer surface thereof to provide friction higher than a predetermined level.

According to the present invention, friction is added to fitting force when the fitting member 420 is fitted into the fixing hole, thereby improving fitting force between the fitting member 420 and the fixing hole 201, 202, 203 above a predetermined level.

As described above, according to the exemplary embodiments, a plurality of pressure support points is formed between the shaft supporter and a fixing hole of a bracket when the shaft supporter is fitted into the fixing hole, thereby stably securing the shaft supporter in the fixing hole.

In addition, according to the exemplary embodiments, the plurality of pressure support points is formed between the shaft supporter and the fixing hole and forcibly secures the shaft supporter, thereby preventing the shaft supporter from separating or deviating from the fixing hole by external impact.

Further, according to the exemplary embodiments, the shaft supporter prevents axial deviation of the shaft, thereby ensuring stable rotation of the shaft while preventing operating failure of the stepping motor.

Further, according to the exemplary embodiments, the shaft supporter is configured to accommodate a predetermined amount of foreign matter generated upon fitting the shaft supporter into the fixing hole, thereby preventing the foreign matter from flowing into the motor.

As such, according to the exemplary embodiments, the shaft supporter provides conditions for ensuring stable rotation of the shaft and prevents foreign matter from intruding into the motor, thereby extending the lifespan of the stepping motor.

Although some exemplary embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. A stepping motor comprising:
a bracket including a fixing hole;
a shaft supporter rotatably supporting one end of a shaft and fitted into the fixing hole; and
a pressure supporter pressing and supporting the fixing hole and the shaft supporter while forming a plurality of pressure support points between the fixing hole and the shaft supporter.

2. The stepping motor according to claim 1, wherein the shaft supporter comprises a support member having an outer diameter larger than an inner diameter of the fixing hole and rotatably supporting the one end of the shaft, and a fitting member protruding from one side of the support member and fitted into the fixing hole.

3. The stepping motor according to claim 2, wherein the pressure supporter comprises a plurality of support projections arranged at constant intervals along an outer circumference of the fitting member to be pressed and supported by an inner circumference of the fixing hole.

4. The stepping motor according to claim 2, wherein the pressure supporter comprises a plurality of support projections arranged at constant intervals along an inner circumference of the fixing hole to be pressed and supported by an inner circumference of the fitting member.

5. The stepping motor according to claim 3, further comprising: a foreign matter accommodating groove formed on a connecting region between the support member and the fitting member, and having a predetermined depth inside the support member.

6. The stepping motor according to claim 4, further comprising: a foreign matter accommodating groove formed on a connecting region between the support member and the fitting member, and having a predetermined depth inside the support member.
